(19) United States
(12) Patent Application Publication
(10) Pub. No.: US 2025/0220531 A1
(43) Pub. Date: Jul. 3, 2025

(54) CELL SELECTION AND/OR RESELECTION METHOD AND APPARATUS

(71) Applicant: VIVO MOBILE COMMUNICATION CO., LTD., Dongguan (CN)

(72) Inventors: Zhihan HUANG, Dongguan (CN); Wenjuan PU, Dongguan (CN); Xiaodong YANG, Dongguan (CN); Jianhui LI, Dongguan (CN)

(73) Assignee: VIVO MOBILE COMMUNICATION CO., LTD., Dongguan (CN)

(21) Appl. No.: 19/084,738

(22) Filed: Mar. 19, 2025

(30) Foreign Application Priority Data
Sep. 29, 2022 (CN) 202211205070.1
Nov. 25, 2022 (CN) 202211494582.4

(51) Int. Cl. H04W 36/08; H04W 36/00; H04W 48/02; H04W 52/02

(52) U.S. Cl. CPC H04W 36/08; H04W 36/0058; H04W 48/02; H04W 52/0206

(57) ABSTRACT

This application discloses a cell selection or reselection method and apparatus. The cell selection or reselection method includes: A terminal receives target configuration information; and the terminal performs cell selection or reselection based on the target configuration information, where the target configuration information is related to network energy-saving, and the target configuration information includes at least one of the following: first configuration information, used to indicate whether the terminal is allowed to select or reselect to a cell; second configuration information, including a first frequency list or a first cell list, where the first frequency list includes a frequency of a cell that supports network energy-saving or a frequency that supports network energy-saving, and the first cell list includes the cell that supports network energy-saving; and third configuration information, used to indicate reselection information related to network energy-saving.

### CROSS-REFERENCE TO RELATED APPLICATIONS

This application is a continuation of International Application No. PCT/CN2023/121954, filed Sep. 27, 2023, which claims priority to Chinese Patent Application No. 202211205070.1, filed Sep. 29, 2022, and Chinese Patent Application No. 202211494582.4, filed Nov. 25, 2022. The entire contents of each of the above-referenced applications are expressly incorporated herein by reference.

### TECHNICAL FIELD

This application pertains to the field of communication technologies, and specifically relates to a cell selection and/or reselection method and apparatus.

### BACKGROUND

In a related technology, when a cell enters an energy-saving state, a network is allowed to perform different processing on different types of terminals (for example, a terminal that supports network energy-saving and legacy user equipment (UE)), and this helps the network perform a corresponding energy-saving operation and management.

However, for the terminal that supports network energy-saving, how to perform cell selection and/or reselection is an urgent problem to be resolved.

### SUMMARY

Embodiments of this application provide a cell selection and/or reselection method and apparatus.

According to a first aspect, a cell selection and/or reselection method is provided, and the method includes:
receiving, by a terminal, target configuration information; and
performing, by the terminal, cell selection and/or reselection based on the target configuration information, where the target configuration information is related to network energy-saving; where
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

According to a second aspect, a cell selection and/or reselection method is provided, and the method includes:
sending, by a network side device, target configuration information to a terminal, where the target configuration information is used to assist the terminal in performing cell selection and/or reselection, and the target configuration information is related to network energy-saving; and
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

According to a third aspect, a cell selection and/or reselection apparatus is provided, and the apparatus includes:
a receiving module, configured to receive target configuration information; and
an execution module, configured to perform cell selection and/or reselection based on the target configuration information, where the target configuration information is related to network energy-saving; where
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

According to a fourth aspect, a cell selection and/or reselection apparatus is provided, and the apparatus includes:
a sending module, configured to send target configuration information to a terminal, where the target configuration information is used to assist the terminal in performing cell selection and/or reselection, and the target configuration information is related to network energy-saving; and
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

According to a fifth aspect, a terminal is provided. The terminal includes a processor and a memory, the memory stores a program or instructions that are capable of running on the processor, and when the program or the instructions are executed by the processor, the steps of the cell selection and/or reselection method according to the first aspect are implemented.

According to a sixth aspect, a terminal is provided, including a processor and a communication interface. The communication interface is configured to receive target configuration information. The processor is configured to perform cell selection and/or reselection based on the target configuration information, where the target configuration information is related to network energy-saving.

According to a seventh aspect, a network side device is provided. The network side device includes a processor and a memory, the memory stores a program or instructions that are capable of running on the processor, and when the program or the instructions are executed by the processor, the steps of the cell selection and/or reselection method according to the second aspect are implemented.

According to an eighth aspect, a network side device is provided, including a processor and a communication interface. The communication interface is configured to send target configuration information to a terminal, where the target configuration information is used to assist the terminal in performing cell selection and/or reselection, and the target configuration information is related to network energy-saving.

According to a ninth aspect, a cell selection and/or reselection system is provided, including a terminal and a network side device. The terminal may be configured to perform the steps of the cell selection and/or reselection method according to the first aspect, and the network side device may be configured to perform the steps of the cell selection and/or reselection method according to the second aspect.

According to a tenth aspect, a readable storage medium is provided. The readable storage medium stores a program or instructions, and when the program or the instructions are executed by a processor, the steps of the cell selection and/or reselection method according to the first aspect are implemented, or the steps of the cell selection and/or reselection method according to the second aspect are implemented.

According to an eleventh aspect, a chip is provided. The chip includes a processor and a communication interface, the communication interface is coupled to the processor, and the processor is configured to run a program or instructions to implement the cell selection and/or reselection method according to the first aspect or the cell selection and/or reselection method according to the second aspect.

According to a twelfth aspect, a computer program product/program product is provided. The computer program product/program product is stored in a storage medium, and the computer program/program product is executed by at least one processor to implement the steps of the cell selection and/or reselection method according to the first aspect or the steps of the cell selection and/or reselection method according to the second aspect.

In the embodiments of this application, after receiving target configuration information related to network energy-saving, a terminal may determine, based on at least one of first configuration information, second configuration information, or third configuration information in the target configuration information, whether selection and/or reselection to a cell is allowed, so that a terminal that supports network energy-saving can determine, based on an indication of a network, whether the terminal can access the cell and how to perform cell selection and/or reselection.

### BRIEF DESCRIPTION OF DRAWINGS

FIG. 1 is a schematic diagram of a wireless communication system to which embodiments of this application can be applied;

FIG. 2 is a first flowchart of a cell selection and/or reselection method according to an embodiment of this application;

FIG. 3 is a second flowchart of a cell selection and/or reselection method according to an embodiment of this application;

FIG. 4 is a first schematic diagram of a structure of a cell selection and/or reselection apparatus according to an embodiment of this application;

FIG. 5 is a second schematic diagram of a structure of a cell selection and/or reselection apparatus according to an embodiment of this application;

FIG. 6 is a schematic diagram of a structure of a communication device according to an embodiment of this application;

FIG. 7 is a schematic diagram of a structure of a terminal according to an embodiment of this application; and

FIG. 8 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and NR terms are used in most of the following descriptions, although these technologies can also be applied to communication systems other than the NR system application, such as the 6^{th} Generation (6G) communication system.

FIG. 1 is a schematic diagram of a wireless communication system to which embodiments of this application can be applied. The wireless communication system shown in FIG. 1 includes a terminal 11 and a network side device 12. The terminal 11 may be a terminal side device such as a mobile phone, a tablet personal computer, a laptop computer that is also referred to as a notebook computer, a Personal Digital Assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smartjewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application.

The network side device 12 may include an access network device or a core network device. The access network device may also be referred to as a radio access network device, a Radio Access Network (RAN), a radio access network function, or a radio access network unit. The access network device may include a base station, a WLAN access point, a WiFi node, and the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art, provided that the same technical effect is achieved. The base station is not limited to a specific technical vocabulary. It should be noted that in the embodiments of this application, a base station in an NR system is merely used as an example for description, but a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a local NEF (Local NEF or L-NEF), a Binding Support Function (BSF), an Application Function (AF), a location management function (LMF), an Enhanced Serving Mobile Location Centre (E-SMLC), a network data analytics function (NWDAF), or the like. It should be noted that, in the embodiments of this application, only a core network device in an NR system is used as an example for description, and a specific type of the core network device is not limited.

To facilitate a clearer understanding of the technical solutions provided in the embodiments of this application, the following first describes some related background knowledge.

### 1. Measurement Criterion for Cell Reselection (Starting Condition for Neighboring Cell Measurement)

After a terminal successfully performs camping, the terminal continues to measure a current cell and starts neighboring cell measurement when signal quality (Srxlev/Squal value) of the current cell is lower than a specific threshold or when a high-priority frequency appears. SintrasearchP and SintrasearchQ are intra-frequency measurement thresholds, and SnonintrasearchP and SnonintrasearchQ are inter-frequency/inter-system measurement thresholds.

### 2. Priority Rule for Cell Reselection

When communication service quality of a serving cell is poor and UE has enabled a plurality of measurement states, if the terminal finds a plurality of neighboring cells that meet a reselection condition, the terminal selects, according to the priority rule for cell reselection, a neighboring cell with a higher priority to access and camp on the neighboring cell.

The priority rule of cell reselection takes an inter-frequency priority, quality of a serving cell, quality of a neighboring cell, and a ping-pong effect into consideration. The priority rule for cell reselection is as follows:

### 1. High-Priority Frequency (New Radio (NR) or Inter-System):

$${S}_{r x l e v} > {Thresh}_{x , h i g h P} or {S}_{q u a l} > {Thresh}_{x , highQ} ;$$

Srxlev indicates a cell selection receiving signal strength value, Thresh_{x,highP} indicates an inter-frequency frequency Reference Signal Receiving Power (RSRP) high-priority reselection threshold, S_{qual} indicates cell selection receiving signal quality, and Thresh_{x,highQ} indicates an inter-frequency frequency Reference Signal Receiving Quality (RSRQ) high-priority reselection threshold

### 2. Different Frequencies of an Intra-Frequency and an Equal Priority: Calculating Specific Values According to an R-Criterion, and Ranking the Values to Obtain an Optimal Cell.

$$\begin{matrix}{R}_{s} = {Q}_{m e a s , s} + {Q}_{hyst} - {Qoffset}_{temp} \\ {R}_{n} = {Q}_{m e a s , n} - {Qoffset}_{temp}\end{matrix}$$

Rₛ indicates a serving cell, Q_{meas,s} indicates a receiving level value of the serving cell, Q_{hyst} indicates a cell reselection hysteresis, Qoffsetₜₑₘₚ indicates a cell offset, Rn indicates a neighboring cell, Q_{meas,n} indicates a receiving level value of the neighboring cell, and Qoffset indicates a cell offset.

### 3. Low-Priority Frequency (NR or Inter-System)

$$\begin{matrix}Power criterion : Srxlev < {Thresh}_{serving , lowP} \& Srxlev > {Thresh}_{x , l o w P} \\ Quality criterion : Squal < {Thresh}_{serving , lowQ} \& Squal > {Thresh}_{x , lowQ}\end{matrix}$$

Thresh_{serving,lowP} indicates a serving frequency RSRP low-priority reselection threshold, Thresh_{x,lowP} indicates an inter-frequency frequency RSRP low-priority reselection threshold, Thresh_{serving,lowQ} indicates a serving frequency RSRQ low-priority reselection threshold, and Thresh_{x,lowQ} indicates an inter-frequency frequency RSRQ low-priority reselection threshold.

With reference to the accompanying drawings, a cell selection and/or reselection method provided in the embodiments of this application is described in detail below by using specific embodiments and application scenarios thereof.

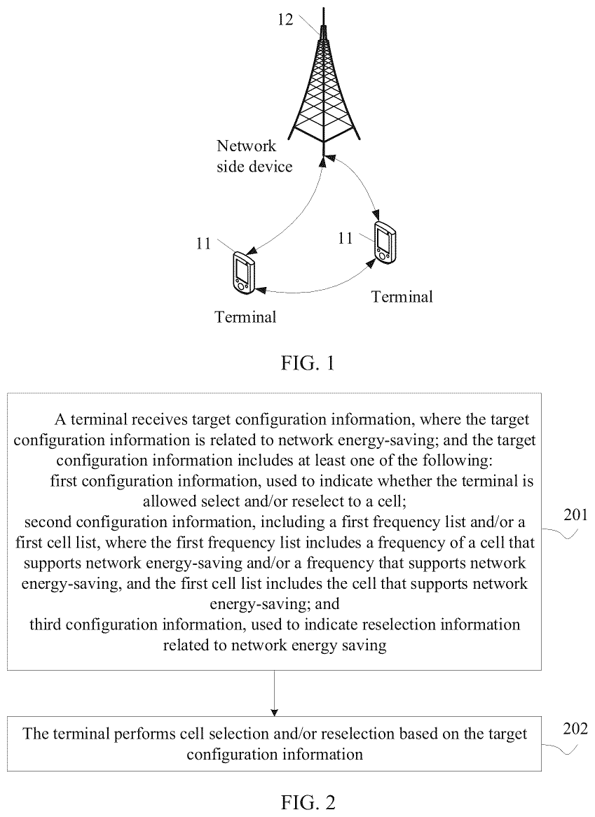

FIG. 2 is a first schematic flowchart of a cell selection and/or reselection method according to an embodiment of this application. As shown in FIG. 2, the method includes step 201 and step 202.

Step 201: A terminal receives target configuration information, where the target configuration information is related to network energy-saving; and
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

It should be noted that this embodiment of this application may be applied to a scenario in which the terminal performs cell selection and/or reselection. The terminal includes but is not limited to the foregoing listed types of the terminal 11. This is not limited in this application.

In some embodiments, the terminal supports network energy-saving.

In some embodiments, the target configuration information is carried by using at least one of the following:
(a) system information; or
(b) dedicated signaling, for example, a Radio Resource Control (RRC) release message.

The foregoing implementation provides a manner of carrying the target configuration information. A network side device adds the target configuration information to the system information or the dedicated signaling. The terminal can determine, based on the received target configuration information, how to perform cell selection and/or reselection.

Step 202: The terminal performs cell selection and/or reselection based on the target configuration information.

For example, after receiving the target configuration information from the network side device via the system information, the terminal can determine, based on the target configuration information related to network energy-saving, how to perform cell selection and/or reselection.

In this embodiment of this application, after receiving the target configuration information related to network energy-saving, the terminal may determine, based on at least one of the first configuration information, the second configuration information, or the third configuration information in the target configuration information, whether selection and/or reselection to a cell is allowed, so that a terminal that supports network energy-saving can determine, based on an indication of a network, whether the terminal can access the cell and how to perform cell selection and/or reselection.

In some embodiments, the first configuration information includes at least one of the following:
(a) A first parameter, used to determine information about whether the terminal is allowed to select and/or reselect to a cell.

In some embodiments, the first parameter includes cell barred (cellBarredNES) indication information of the terminal that supports network energy-saving. In some embodiments, the cell supports network energy-saving.
(b) A second parameter, used to determine information about whether the terminal is allowed to reselect to an intra-frequency cell.

In some embodiments, the second parameter includes intra-frequency reselection (intraFreqReselectionNES) indication information of the terminal that supports network energy-saving.

In the foregoing implementation, an execution solution of whether to allow selection and/or reselection to a cell is provided for the terminal based on the first parameter and the second parameter, that is, the terminal can determine, based on the first parameter, whether the terminal is allowed to select and/or reselect to the cell that supports network energy-saving, and can determine, based on the second parameter, whether the terminal is allowed to reselect to an intra-frequency cell.

In some embodiments, that the terminal performs cell selection and/or reselection based on the target configuration information may be implemented in the following manners 1 to 6.

Manner 1: In a case that the first configuration information includes the first parameter and the first parameter is configured as barred, the terminal is barred from selecting and/or reselecting to the cell.

In some embodiments, the first parameter includes cellBarredNES, and cellBarredNES is configured as barred, the terminal that supports network energy-saving is barred from selecting and/or reselecting to the cell that supports network energy-saving.

Manner 2: In a case that the first configuration information includes the first parameter and the first parameter is configured as not barred, the terminal is allowed to select and/or reselect to the cell.

In some embodiments, in a case that the first parameter includes cellBarredNES and cellBarredNES is configured as not barred, the terminal that supports network energy-saving is allowed to select and/or reselect to the cell that supports network energy-saving.

Manner 3: In a case that the first configuration information does not include the first parameter, the terminal is barred from selecting and/or reselecting to the cell, or the terminal is allowed to select and/or reselect to the cell.

In some embodiments, in a case that the first configuration information does not include cellBarredNES, the terminal that supports network energy-saving may be barred from selecting and/or reselecting to the cell, and may be also allowed to select and/or reselect to the cell.

Manner 4: In a case that the first configuration information includes the second parameter and the second parameter is configured as allowed, the terminal is allowed to select and/or reselect to an unbarred intra-frequency cell.

In some embodiments, if the second parameter includes intraFreqReselectionNES, and intraFreqReselectionNES is configured as allowed, the terminal that supports network energy-saving is allowed to select and/or reselect to an unbarred intra-frequency cell.

Manner 5: In a case that the first configuration information includes the second parameter and the second parameter is configured as not allowed, the terminal is not allowed to select and/or reselect to an intra-frequency cell.

In some embodiments, in a case that the second parameter includes intraFreqReselectionNES and intraFreqReselectionNES is configured as not allowed, the terminal that supports network energy-saving is not allowed to select and/or reselect to an intra-frequency cell.

Manner 6: In a case that the first configuration information does not include the second parameter, the terminal is barred from selecting and/or reselecting to the cell.

In some embodiments, in a case that the first configuration information does not include intraFreqReselectionNES, it indicates that for the terminal that supports network energy-saving, the cell is barred, for example, the cell does not support network energy-saving.

In the foregoing implementation, an execution solution of whether to allow selection and/or reselection to a cell is provided for the terminal based on the first parameter and the second parameter, that is, the terminal can determine, based on the first parameter, whether the terminal is allowed to select and/or reselect to the cell that supports network energy-saving, and can determine, based on the second parameter, whether the terminal is allowed to reselect to an intra-frequency cell.

In some embodiments, the terminal may further perform cell selection and/or reselection based on the first information and/or the second information. The first information includes cell barred (cellBarred) indication information, and the second information includes intra-frequency reselection (intraFreqReselection) indication information.

That the terminal performs cell selection and/or reselection based on the first information may be implemented in the following manners 1 to 4.

Manner 1: In a case that the first information cellBarred is configured as barred and cellBarred is configured to be ignorable by the terminal that supports network energy-saving, the terminal that supports network energy-saving is allowed to select and/or reselect to the cell that supports network energy-saving, and legacy UE is barred from selecting and/or reselecting to the cell that supports network energy-saving.

Manner 2: In a case that cellBarred is configured as barred and cellBarred is configured as unignorable by the terminal that supports network energy-saving, the terminal that supports network energy-saving and the legacy UE are both barred from selecting and/or reselecting to the cell that supports network energy-saving.

Manner 3: In a case that cellBarred is configured as not barred and cellBarred is configured as ignorable by the terminal that supports network energy-saving, the terminal that supports network energy-saving is allowed to select and/or reselect to the cell that supports network energy-saving, and the legacy UE is also allowed to select and/or reselect to the cell that supports network energy-saving.

Manner 4: In a case that cellBarred is configured as not barred and cellBarred is configured as unignorable by the terminal that supports network energy-saving, the terminal that supports network energy-saving and the legacy UE are both allowed to select and/or reselect to the cell that supports network energy-saving.

That the terminal performs cell selection and/or reselection based on the second information may be implemented in the following manners 1 to 4.

Manner 1: In a case that the second information intraFreqReselection is configured as allowed and intraFreqReselection is configured as ignorable by the terminal that supports network energy-saving, the legacy UE is allowed to reselect to an unbarred intra-frequency cell, and no limitation is imposed on the terminal that supports network energy-saving.

Manner 2: In a case that intraFreqReselection is configured as allowed and intraFreqReselection is configured as unignorable by the terminal that supports network energy-saving, the terminal that supports network energy-saving and the legacy UE are both allowed to reselect to an unbarred intra-frequency cell.

Manner 3: In a case that intraFreqReselection is configured as not allowed and intraFreqReselection is configured as ignorable by the terminal that supports network energy-saving, no limitation is imposed on the terminal that supports network energy-saving, and the legacy UE is barred from reselecting to an intra-frequency cell.

Manner 4: In a case that intraFreqReselection is configured as not Allowed and intraFreqReselection is configured as unignorable by the terminal that supports network energy-saving, the terminal that supports network energy-saving and the legacy UE are both barred from reselecting to an intra-frequency cell.

In the foregoing implementation, the terminal may perform cell selection and/or reselection based on the first configuration information in the target configuration information, or the terminal may perform cell selection and/or reselection based on the first information and the second information.

That the terminal performs cell selection and/or reselection based on the first configuration information in the target configuration information is described below in detail with reference to specific Embodiment 1 and Embodiment 2.

### Embodiment 1: A Case that cellBarred can be Ignored by the Terminal that Supports Network Energy-Saving

Step 1: The terminal that supports network energy-saving receives first configuration information such as a cellBarred via system information, and a cell enters a dormant state.

Step 2: If cellBarred is configured as barred, and cellBarred is configured as ignorable by the terminal that supports network energy-saving, legacy UE is not allowed to camp on a cell that currently supports network energy-saving, and the terminal that supports network energy-saving is allowed to camp on the cell.

### Embodiment 2: A Case that the Terminal that Supports Network Energy-Saving Receives a First Parameter

Step 1: The terminal that supports network energy-saving receives first configuration information such as the first parameter via system information, and a cell enters a dormant state.

Step 2: The terminal that supports network energy-saving performs one of the following operations:
(a) When a value of the first parameter is barred, for example, barred, the terminal that supports network energy-saving is barred from camping on a cell that supports network energy-saving.
(b) When a value of the first parameter is not barred, for example, notBarred, the terminal that supports network energy-saving can camp on a cell that supports network energy-saving.
(c) In a case that the first parameter does not exist, the terminal that supports network energy-saving may be barred from camping on a cell that currently supports network energy-saving, or the terminal that supports network energy-saving may be allowed to camp on a cell that currently supports network energy-saving.

In some embodiments, the terminal may perform cell selection and/or reselection based on the second configuration information in the target configuration information, which is implemented in any one of the following manners, including manners [1] and [2].

Manner [1]: In a case that the second configuration information includes the first frequency list, the terminal performs cell measurement based on a frequency that meets a reselection measurement condition and/or a frequency in the first frequency list.

In an implementation, the terminal may first determine the frequency that meets the reselection measurement condition, and then perform cell measurement on the frequency that meets the reselection measurement condition, to obtain a cell corresponding to at least one candidate frequency, and finally, perform cell selection and/or reselection by using a cell selection and/or reselection criteria. For example, a cell reselection R-criterion is used to rank cells corresponding to a plurality of candidate frequencies, and a cell corresponding to a frequency with a first ranking (that is, a highest priority) is preferentially selected.

In a second implementation, the terminal may directly perform cell measurement on the frequency in the first frequency list to obtain a cell corresponding to at least one candidate frequency, and finally perform cell selection and/or reselection by using a cell selection and/or reselection criteria.

In a third implementation, the terminal may simultaneously perform cell measurement on the frequency that meets the reselection measurement condition and the frequency in the first frequency list, to obtain a cell corresponding to at least one candidate frequency, and finally perform cell selection and/or reselection by using a cell selection and/or reselection criteria.

In a fourth implementation, the terminal may perform measurement on a frequency, in the frequency that meets the reselection measurement condition, including no frequency in the first frequency list, to obtain a cell corresponding to at least one candidate frequency, and finally perform cell selection and/or reselection by using a cell selection and/or reselection criteria.

It should be noted that the terminal may further determine, based on an energy-saving preference of the terminal, whether to directly select a frequency and/or a cell that supports network energy-saving.

In some embodiments, the terminal performs cell measurement based on the frequency that meets the reselection measurement condition and/or the frequency in the first frequency list, which is implemented in either of the following manners, including manners (1) or (2).

Manner (1): The terminal starts the frequency in the first frequency list to perform cell measurement.

For example, measurement frequencies include a frequency 1, a frequency 2, and a frequency 3, where the first frequency list includes the frequency 1 and the frequency 3, and in this case, the terminal performs cell measurement based on the frequency 1 and the frequency 2.

Manner (2): The terminal determines a target frequency based on the frequency that meets the reselection measurement condition and/or the frequency in the first frequency list, and starts the target frequency to perform cell measurement, where the target frequency does not include the frequency in the first frequency list.

For example, the terminal first determines that frequencies that meet the reselection measurement condition include a frequency 1, a frequency 2, and a frequency 3, where the frequency list includes the frequency 1 and the frequency 3, and in this case, the terminal determines that the frequency 2 is a target frequency, and performs cell measurement based on the frequency 2.

In the foregoing implementation, in a case that the second configuration information includes the first frequency list, the terminal can perform cell measurement in different manners based on the first frequency list, thereby providing different execution solutions for the terminal to perform cell selection and/or reselection.

Manner [2]: In a case that the second configuration information includes the first cell list, the terminal performs cell selection and/or reselection based on a result of a measured cell and/or a measurement result of a cell in the first cell list.

In some embodiments, the result of the measured cell includes the measurement result of the cell in the first cell list. During cell reselection, measurement results are ranked first, and then cell selection and/or reselection is performed by using a cell selection and/or reselection criteria.

In some embodiments, that the terminal performs cell reselection based on a result of a measured cell and/or a measurement result of a cell in the first cell list may be implemented by using the following step [1] and step [2].

Step [1]: The terminal obtains, based on the result of the measured cell and/or the measurement result of the cell in the first cell list, a cell ranking that meets criteria of a high-priority frequency, an intra-frequency frequency, and a low-priority frequency.

Step [2]: The terminal preferentially selects the cell in the first cell list from the cell ranking to perform cell reselection.

For example, if a current cell ranking result is that a cell 1 is greater than a cell 2 and the cell 2 is greater than a cell 3, where the cell 2 is a cell that is in the first cell list and that supports network energy-saving, the cell 2 is preferentially selected to perform cell reselection.

In some embodiments, the terminal performs cell reselection in a cell, other than the cell in the first cell list, in the cell ranking.

For example, if a current cell ranking result is that a cell 1 is greater than a cell 2 and the cell 2 is greater than a cell 3, where the cell 2 is a cell that is in the first cell list and that supports network energy-saving, the cell 1 and the cell 3 are preferentially selected to perform cell reselection.

In some embodiments, the terminal performs cell reselection after ranking the cell in the first cell list after other cells in the cell ranking.

For example, if a current cell ranking result is that a cell 1 is greater than a cell 2, the cell 2 is greater than a cell 3, and the cell 3 is greater than a cell 4, where the cell 2 and the cell 4 are cells in the first cell list that support network energy-saving, the cell 1 and the cell 3 are preferentially selected to perform cell reselection, and the cell 2 and the cell 4 are ranked after the cell 1 and the cell 3 based on a ranking result.

In this embodiment, in a case that the second configuration information includes the first cell list, the terminal can select different manners based on the first cell list to perform cell reselection, thereby providing different execution solutions for the terminal to perform cell selection and/or reselection.

In the foregoing implementation, the terminal may perform cell selection and/or reselection based on the second configuration information in the target configuration information. That the terminal performs cell selection and/or reselection based on the second configuration information in the target configuration information is described below in detail with reference to specific Embodiment 3 to Embodiment 5.

### Embodiment 3: The Terminal that Supports Network Energy-Saving Reselects to a Cell that Supports Network Energy-Saving

Step 1: The terminal receives first frequency list information and first cell list information via system information, where a frequency in a first frequency list is a network energy-saving frequency, and a cell in a first cell list is a cell that supports network energy-saving.

Step 2: At a specific moment, signal quality of a cell in which the terminal is located is lower than an inter-frequency or intra-frequency reselection measurement threshold, and the terminal compares a measurement frequency with a frequency in the first frequency list, and preferentially starts a frequency that is in the measurement frequency and that is included in the first frequency list. For example, if the measurement frequency includes a frequency 1, a frequency 2, and a frequency 3, and frequencies included in the first frequency list include the frequency 1 and the frequency 3, measurement for the frequency 1 and the frequency 3 is started.

Step 3: In a case in that there are a plurality of cells corresponding to frequencies that meet a measurement condition, the terminal obtains a cell ranking list based on a cell reselection R-criterion. For example, if a current cell ranking result is that a cell 1 is greater than a cell 2 and the cell 2 is greater than a cell 3, where the cell 2 is an energy-saving cell in the first cell list, the terminal reselects to the cell 2.

### Embodiment 4: The Terminal that Supports Network Energy-Saving Reselects to a Non-Network Energy-Saving Cell

Step 1: The terminal receives first cell list information via system information, where a frequency in a first frequency list is a network energy-saving frequency, and a cell in a first cell list is a network energy-saving cell.

Step 2: At a specific moment, signal quality of a cell in which the terminal is located is lower than an inter-frequency or intra-frequency reselection measurement threshold, measurement is started.

Step 3: The terminal obtains a cell ranking list based on a cell reselection R-criterion, and when selecting a cell, the terminal excludes a cell in the first cell list.

For example, if a current cell ranking result is that a cell 1 is greater than a cell 2 and the cell 2 is greater than a cell 3, where the cell 2 is an energy-saving cell in the first cell list, the terminal reselects to the cell 1, where the cell 1 is a non-network energy-saving cell.

### Embodiment 5: The Terminal that Supports Network Energy-Saving Directly Selects to an Energy-Saving Cell

Step 1: The terminal receives first frequency list information and first cell list information via system information or dedicated signaling.

Step 2: The terminal directly measures a frequency in a first frequency list or a cell in a first cell list, and reselects to a cell in the first frequency list or the cell in the first list when a measurement criterion is met.

In some embodiments, the terminal may further perform cell selection and/or reselection based on the third configuration information in the target configuration information, where the third configuration information includes at least one of the following:
(a) A first intra-frequency measurement threshold, where the first intra-frequency measurement threshold is lower than or higher than a reference intra-frequency measurement threshold.
(b) A first inter-frequency or inter-system measurement threshold, where the first inter-frequency or inter-system measurement threshold is lower than or higher than a reference inter-frequency or inter-system measurement threshold.
(c) An intra-frequency measurement threshold offset, where the intra-frequency measurement threshold offset may be configured by a network, or may be agreed upon in a protocol.

In some embodiments, if the terminal that supports network energy-saving has an energy saving requirement, the terminal performs measurement based on the first intra-frequency measurement threshold and/or the first inter-frequency or inter-system measurement threshold, or performs measurement by subtracting the intra-frequency measurement threshold offset from the reference intra-frequency measurement threshold.
(d) An inter-frequency or inter-system measurement threshold offset, where the inter-frequency or inter-system measurement threshold offset may be configured by a network, or may be agreed upon in a protocol.

In some embodiments, if the terminal that supports network energy-saving has an energy saving requirement, the terminal starts measurement based on the first intra-frequency measurement threshold and/or the first inter-frequency or inter-system measurement threshold, or starts measurement by subtracting the inter-frequency or inter-system measurement threshold offset from the reference inter-frequency or inter-system measurement threshold.
(e) A first offset value, used to indicate an offset between a target cell and a camped-on cell.
(f) A second cell list, where the second cell list includes the cell that supports network energy-saving.
(g) An offset list, where the offset list includes an offset between each cell in the second cell list and the camped-on cell.
(h) A second measurement threshold, where the second measurement threshold is a threshold used to start measurement for the cell that supports network energy-saving.
(i) A first high-priority absolute threshold, where the first high-priority absolute threshold is an absolute threshold used by the terminal to determine whether reselection to the cell that supports network energy-saving on a high-priority frequency is allowed.
(g) A first low-priority absolute threshold, where the first low-priority absolute threshold is an absolute threshold used by the terminal to determine whether reselection to the cell that supports network energy-saving on a low-priority frequency is allowed.
(k) A first equal-priority absolute threshold, where the first equal-priority absolute threshold is an absolute threshold used by the terminal to determine whether the cell that supports network energy-saving on an intra-frequency or an equal-priority frequency is allowed to participate in R-criterion ranking.
(l) A first energy-saving cell offset list, where the first energy-saving cell offset list is used by the terminal to determine an offset between an energy-saving cell and the camped-on cell.

In some embodiments, that the terminal performs cell selection and/or reselection based on the third configuration information in the target configuration information may be implemented in at least one of the following manners, including manners [1] to [11].

Manner [1]: In a case that signal quality of the current cell is lower than the reference intra-frequency measurement threshold and the reference inter-frequency or inter-system measurement threshold, the terminal does not start cell measurement.

In some embodiments, the reference intra-frequency measurement threshold is, for example, SintrasearchP or SintrasearchQ, and the reference inter-frequency or inter-system measurement threshold is, for example, SnonintrasearchP or SnonintrasearchQ.

Manner [2]: In a case that signal quality of the current cell is lower than the reference intra-frequency measurement threshold and the reference inter-frequency or inter-system measurement threshold, the terminal chooses, based on an energy-saving preference of the terminal, to start cell measurement.

Manner [3]: In a case that signal quality of the current cell is lower than the first intra-frequency measurement threshold and the first inter-frequency or inter-system measurement threshold, the terminal starts cell measurement.

Manner [4]: In a case that signal quality of the current cell is lower than a second intra-frequency measurement threshold or is lower than a second inter-frequency or inter-system measurement threshold, the terminal starts cell measurement, where the second intra-frequency measurement threshold is determined by the reference intra-frequency measurement threshold and the intra-frequency measurement threshold offset, and the second inter-frequency or inter-system measurement threshold is determined by the reference inter-frequency or inter-system measurement threshold and the inter-frequency or inter-system measurement threshold offset.

Manner [5]: The terminal determines a cell reselection criterion based on the first offset value such as Qoffset, to adjust a reselection difficulty, and increase or decrease the value, so that an intra-frequency or inter-frequency equal-priority cell reselection difficulty can be increased or decreased.

Manner [6]: The terminal determines a cell reselection criterion based on the second cell list and the offset list, for example, each target energy-saving cell in the second cell list corresponds to one offset value in the offset list, where a larger offset value indicates a higher difficulty of reselecting to a corresponding energy-saving cell, and a smaller offset value indicates a lower difficulty of reselecting to a corresponding energy-saving cell.

Manner [7]: In a case that signal quality of the current cell is lower than the second measurement threshold, the terminal starts measurement of a network energy-saving neighboring cell, where the network energy-saving cell may be determined by using a network notification or the second cell list.

Manner [8]: The terminal determines a cell reselection criterion based on the first high-priority absolute threshold. For example, in a high-priority frequency, when signal quality of a network energy-saving cell is higher than the first high-priority absolute threshold, the terminal is allowed to reselect to the network energy-saving cell, where the first high-priority absolute threshold may be higher than a high-priority absolute threshold (ThreshX, HighQ or ThreshX, HighP) in an existing mechanism. When there are a plurality of non-network energy-saving cells that meet the high-priority absolute threshold in the existing mechanism and a plurality of network energy-saving cells that meet the first high-priority absolute threshold, a strongest cell is selected based on the R-criterion. The network energy-saving cell may be determined by using a network notification or a second cell list.

Manner [9]: The terminal determines a cell reselection criterion based on the first low-priority absolute threshold. For example, when signal quality of a serving cell is lower than a threshold (ThreshServing, LowQ or ThreshServing, LowP) in an existing mechanism, in a low-priority frequency, when signal quality of a network energy-saving cell is higher than a second low-priority absolute threshold, the terminal is allowed to reselect to the network energy-saving cell, where the second low-priority absolute threshold may be higher than a low-priority absolute threshold (ThreshX, LowQ or ThreshX, LowQ) in the existing mechanism. The network energy-saving cell may be determined by using a network notification or a second cell list.

Manner [10]: The terminal determines a cell reselection criterion based on the first equal-priority absolute threshold. For example, in an intra-frequency or equal-priority frequency, when signal quality of a network energy-saving cell is higher than the first equal-priority absolute threshold, a network energy-saving cell that meets a condition and another non-network energy-saving cell are ranked based on an R-criterion, a strongest cell is selected based on a ranking result; and when signal quality of a network energy-saving cell is not higher than the first equal-priority absolute threshold, R-criterion ranking is performed only on the non-network energy-saving cell, and a strongest non-network energy-saving cell is selected based on the R-criterion. The network energy-saving cell may be determined by using a network notification or a second cell list.

Manner [11]: The terminal determines a cell reselection criterion based on the first energy-saving cell offset list. The first energy-saving cell offset list includes at least one offset value, each energy-saving cell corresponds to one offset value, and the offset value is an offset between an energy-saving cell and a camped-on cell in terms of a measured value (for example, RSRP or RSRQ). For example, in the intra-frequency or equal-priority frequency, all cells are ranked based on the R-criterion, and the network energy-saving cell determines an R value of the R-criterion based on the first energy-saving cell offset list. A larger offset value indicates a higher difficulty of reselecting to a corresponding energy-saving cell and correspondingly a lower ranking, and a smaller offset value indicates a lower difficulty of reselecting to a corresponding energy-saving cell and correspondingly a higher ranking. A specific offset value depends on a network configuration. The network energy-saving cell may be determined by using a network notification or a second cell list.

In the foregoing implementation, different implementation solutions are provided for the terminal based on different parameters in the third configuration information to perform cell selection and/or reselection, so that the terminal can determine, based on the different parameters in the third configuration information, how to perform cell reselection.

In the foregoing implementation, the terminal may perform cell selection and/or reselection based on the third configuration information in the target configuration information. That the terminal performs cell selection and/or reselection based on the third configuration information in the target configuration information is described below in detail with reference to specific Embodiment 6 to Embodiment 12.

### Embodiment 6: A Case that Legacy UE that Camps on a Network Energy-Saving Cell Reselects to a Non-Network Energy-Saving Cell, and the Terminal that Supports Network Energy-Saving Still Camps on a Current Cell

Step 1: After the terminal receives a first intra-frequency measurement threshold, a first inter-frequency or inter-system measurement threshold, a first offset value, a reference intra-frequency measurement threshold (Sintrasearch), and a reference inter-frequency or inter-system measurement threshold (Snonintrasearch) via system information, the cell enters a dormant state.

Step 2: In a case that signal quality of the current cell is lower than Sintrasearch and Snonintrasearch, the legacy UE starts neighboring cell measurement, and the terminal that supports network energy-saving and/or a terminal that has an energy-saving requirement do/does not start neighboring cell measurement.

It should be noted that, to ensure that the legacy UE is switched off from a network energy-saving state as soon as possible, a network configures high Sintrasearch and high Snonintrasearch. In this case, the terminal that supports network energy-saving and/or has an energy-saving requirement does not want to be switched off, and therefore, the terminal may choose not to start corresponding neighboring cell measurement.

Step 3: The legacy UE reselects to an optimal cell that meets R-criterion ranking.

It should be noted that the network may make, by adjusting Qoffset, it easier for the legacy UE to reselect to another cell, for example, decreasing a value of Qoffset.

### Embodiment 7: The Terminal that Supports Network Energy-Saving Reselects to an Energy-Saving Cell

Step 1: After the terminal receives a first intra-frequency threshold, a first inter-frequency threshold, a first offset value, a second target cell, a second offset list, a reference intra-frequency measurement threshold (Sintrasearch), and a reference inter-frequency or inter-system measurement threshold (Snonintrasearch) via system information, the cell enters a dormant state.

Step 2: When signal quality of the current cell is lower than the first intra-frequency threshold or the first inter-frequency threshold, the terminal that supports network energy-saving starts neighboring cell measurement, and legacy UE does not start neighboring cell measurement.

It should be noted that, to ensure that the terminal that supports network energy-saving can reselect as soon as possible, a network configures a relatively high first intra-frequency threshold or first inter-frequency threshold.

Step 3: The terminal that supports network energy-saving finds a corresponding offset by using the second target cell and the second offset list. For example, the second target cell is an energy-saving cell 1, and an offset in the second offset list is an offset 1 corresponding to the target energy-saving cell 1. To make it easier for the terminal that supports energy saving to reselect to the cell 1, an extremely small offset 1 is configured. An R-criterion is calculated by using the offset, and the terminal reselects to the energy-saving cell 1.

### Embodiment 8: Network Energy-Saving Cell Measurement is Started

Step 1: A terminal receives a second measurement threshold via system information.

Step 2: When signal quality of a serving cell of the terminal is lower than a reference measurement threshold, the terminal starts non-network energy-saving cell measurement.

Step 3: When the signal quality of the serving cell is lower than the second measurement threshold, the terminal starts network energy-saving cell measurement.

### Embodiment 9: For a High-Priority Frequency, the Terminal Reselects to a Network Energy-Saving Cell

Step 1: The terminal receives a first high-priority absolute threshold via system information.

Step 2: The terminal performs one of the following operations based on a measurement result.
(a) When there is no network energy-saving cell that is higher than the first high-priority absolute threshold, the terminal reselects to a non-energy-saving cell that meets a high-priority absolute threshold (ThreshX, HighQ or ThreshX, HighP) in an existing mechanism.
(b) When there is a network energy-saving cell that is higher than the first high-priority absolute threshold, the terminal is allowed to reselect to the network energy-saving cell, and when there are a plurality of energy-saving cells and non-energy-saving cells that meet a condition, a strongest cell is selected based on R-criterion ranking.

### Embodiment 10: For a Low-Priority Frequency, the Terminal Reselects to a Network Energy-Saving Cell

Step 1: The terminal receives a first low-priority absolute threshold via system information.

Step 2: When signal quality of the current serving cell is lower than a reference threshold (for example, ThreshServing, LowQ or ThreshServing, LowP), the terminal performs the following operation based on a measurement result.
(a) When there is no network energy-saving cell that is higher than the first low-priority absolute threshold, the terminal reselects to a non-energy-saving cell that meets a low-priority absolute threshold (ThreshX, LowQ or ThreshX, LowP) in an existing mechanism.
(b) When there is a network energy-saving cell that is higher than the first low-priority absolute threshold, the terminal is allowed to reselect to the network energy-saving cell.

### Embodiment 11: For an Intra-Frequency Equal-Priority Frequency, the Terminal Reselects to a Network Energy-Saving Cell

Step 1: The terminal receives a first equal-priority absolute threshold via system information.

Step 2: The terminal performs one of the following operations based on a cell measurement result.
(a) When there is no network energy-saving cell whose signal is greater than the first equal-priority absolute threshold, the terminal ranks non-network energy-saving cells based on an R-criterion, and selects a strongest cell based on a ranking result.
(b) When there is a network energy-saving cell whose quality is greater than the first equal-priority absolute threshold, the terminal performs R-criterion ranking on a network energy-saving cell that meets a condition and other non-network energy-saving cells, and selects a strongest cell based on a ranking result.

### Embodiment 12: For an Intra-Frequency Equal-Priority Frequency, the Terminal is Selects to a Network Energy-Saving Cell

Step 1: The terminal receives a first energy-saving cell offset list via system information.

Step 2: The terminal calculates an R value of the energy-saving cell based on a measurement result and the first energy-saving offset list.

Step 3: The terminal performs R-criterion ranking based on a non-energy-saving cell measurement result and the R value of the energy-saving cell calculated in step 2, and selects a strongest cell based on a ranking result.

In some embodiments, when the terminal is not configured with the target configuration information, implementation is implemented in the following manner, including a manner [1]:

Manner [1]: The terminal performs cell reselection, and selects, according to an existing cell reselection rule, a normal cell that meets a condition. When the terminal cannot find a non-network energy-saving cell that meets a reselection condition, a network energy-saving cell is considered, where the cell that meets the reselection condition is a cell that meets an R-criterion in an existing mechanism. When there are a plurality of network energy-saving cells that meet a reselection condition, the terminal selects a strongest network energy-saving cells based on R-criterion ranking.

In the foregoing implementation, when the terminal is not configured with the target configuration information, cell selection and/or reselection is performed. That the terminal performs cell selection and/or reselection in a case that the terminal is not configured with the target configuration information is described below in detail with reference to specific Embodiment 13.

### Embodiment 13: The Terminal Reselects to an Energy-Saving Cell

Step 1: The terminal performs one of the following operations based on a measurement result.
(a) When a measurement result of a non-network energy-saving cell does not meet a reselection condition, the terminal ranks network energy-saving cells based on an R-criterion, and selects a strongest network energy-saving cell.
(b) When there is a non-network energy-saving cell whose measurement result meets the reselection condition, the terminal selects a strongest non-network energy-saving cell based on R-criterion ranking, where the R-criterion ranking does not include the network energy-saving cell.

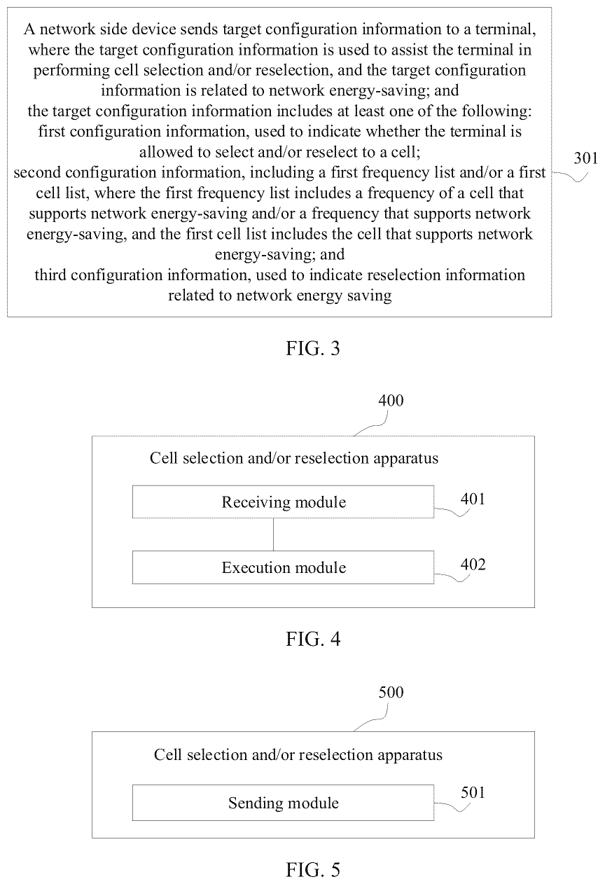

FIG. 3 is a second schematic flowchart of a cell selection and/or reselection method according to an embodiment of this application. As shown in FIG. 3, the method includes step 301.

Step 301: A network side device sends target configuration information to a terminal, where the target configuration information is used to assist the terminal in performing cell selection and/or reselection, and the target configuration information is related to network energy-saving; and
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

It should be noted that this embodiment of this application may be applied to a scenario in which the terminal performs cell selection and/or reselection. The terminal includes but is not limited to the foregoing listed types of the terminal 11. This is not limited in this application, and the terminal supports network energy-saving. The network side device may include but is not limited to the foregoing listed types of the network side device 12. This is not limited in this application.

In this embodiment, after the network side device sends the target configuration information related to network energy-saving to the terminal, the terminal performs cell selection and/or reselection based on the target configuration information.

In some embodiments, the target configuration information is carried by using at least one of the following:
(a) system information; or
(b) dedicated signaling, for example, a Radio Resource Control (RRC) release message.

The foregoing implementation provides a manner of carrying the target configuration information. The network side device adds the target configuration information to the system information or dedicated information. Correspondingly, the terminal can determine, based on the received target configuration information, how to perform cell selection and/or reselection.

In the cell selection and/reselection method provided in this embodiment of this application, the network side device sends the target configuration information related to network energy-saving to the terminal, and after receiving the target configuration information related to network energy-saving, the terminal may determine, based on at least one of the first configuration information, the second configuration information, or the third configuration information in the target configuration information, whether selection and/or reselection to a cell is allowed, so that a terminal that supports network energy-saving can determine, based on an indication of a network, whether the terminal can access the cell and how to perform cell selection and/or reselection.

In some embodiments, the first configuration information includes at least one of the following:
(a) a first parameter, used to determine information about whether the terminal is allowed to select and/or reselect to a cell; or
(b) a second parameter, used to determine information about whether the terminal is allowed to reselect to an intra-frequency cell.

In the foregoing implementation, the network side device sends the first parameter and the second parameter to the terminal, so that an execution solution of whether to allow selection and/or reselection to a cell is provided for the terminal, that is, the terminal can determine, based on the first parameter, whether the terminal is allowed to select and/or reselect to the cell that supports network energy-saving, and can determine, based on the second parameter, whether the terminal is allowed to reselect to an intra-frequency cell.

In some embodiments, the third configuration information includes at least one of the following:
(a) a first intra-frequency measurement threshold, where the first intra-frequency measurement threshold is lower than or higher than a reference intra-frequency measurement threshold;
(b) a first inter-frequency or inter-system measurement threshold, where the first inter-frequency or inter-system measurement threshold is lower than or higher than a reference inter-frequency or inter-system measurement threshold;
(c) an intra-frequency measurement threshold offset;
(d) an inter-frequency or inter-system measurement threshold offset;
(e) a first offset value, used to indicate an offset between a target cell and a camped-on cell;
(f) a second cell list, where the second cell list includes the cell that supports network energy-saving;
(g) an offset list, where the offset list includes an offset between each cell in the second cell list and the camped-on cell;
(h) a second measurement threshold, where the second measurement threshold is a threshold used to start measurement for the cell that supports network energy-saving;
(i) a first high-priority absolute threshold, where the first high-priority absolute threshold is an absolute threshold used by the terminal to determine whether reselection to the cell that supports network energy-saving on a high-priority frequency is allowed;
(j) a first low-priority absolute threshold, where the first low-priority absolute threshold is an absolute threshold used by the terminal to determine whether reselection to the cell that supports network energy-saving on a low-priority frequency is allowed;
(k) a first equal-priority absolute threshold, where the first equal-priority absolute threshold is an absolute threshold used by the terminal to determine whether the cell that supports network energy-saving on an intra-frequency or an equal-priority frequency is allowed to participate in R-criterion ranking;
(l) a first energy-saving cell offset list, where the first energy-saving cell offset list is used by the terminal to determine an offset between an energy-saving cell and the camped-on cell.

In the foregoing implementation, the network side device sends the third configuration information to the terminal, so that the terminal can perform cell selection and/or reselection based on different parameters in the third configuration information.

The cell selection and/or reselection method provided in this embodiment of this application may be performed by a cell selection and/or reselection apparatus. In this embodiment of this application, the cell selection and/or reselection apparatus according to an embodiment of this application is described by using an example in which the cell selection and/or reselection apparatus performs the cell selection and/or reselection method.

FIG. 4 is a first schematic diagram of a structure of a cell selection and/or reselection apparatus according to an embodiment of this application. As shown in FIG. 4, the cell selection and/or reselection apparatus 400 includes:
a receiving module 401, configured to receive target configuration information; and
an execution module 402, configured to perform cell selection and/or reselection based on the target configuration information, where the target configuration information is related to network energy-saving; where
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

The cell selection and/or reselection apparatus provided in this embodiment of this application receives the target configuration information related to network energy-saving, and therefore may determine, based on at least one of the first configuration information, the second configuration information, or the third configuration information in the target configuration information, whether selection and/or reselection to a cell is allowed, so that a terminal that supports network energy-saving can determine, based on an indication of a network, whether the terminal can access the cell and how to perform cell selection and/or reselection.

In some embodiments, the first configuration information includes at least one of the following:
a first parameter, used to determine information about whether the terminal is allowed to select and/or reselect to a cell; or
a second parameter, used to determine information about whether the terminal is allowed to reselect to an intra-frequency cell.

In some embodiments, the execution module 402 is further used for at least one of the following:
in a case that the first configuration information includes the first parameter and the first parameter is configured as barred, barring selection and/or reselection to the cell;
in a case that the first configuration information includes the first parameter and the first parameter is configured as not barred, allowing selection and/or reselection to the cell;
in a case that the first configuration information does not include the first parameter, barring selection and/or reselection to the cell, or allowing selection and/or reselection to the cell;
in a case that the first configuration information includes the second parameter and the second parameter is configured as allowed, allowing selection and/or reselection to an unbarred intra-frequency cell;
in a case that the first configuration information includes the second parameter and the second parameter is configured as not allowed, not allowing selection and/or reselection to an intra-frequency cell; or
in a case that the first configuration information does not include the second parameter, barring selection and/or reselection to the cell.

In some embodiments, the execution module 402 is further used for at least one of the following:
in a case that the second configuration information includes the first frequency list, performing cell measurement based on a frequency that meets a reselection measurement condition and/or a frequency in the first frequency list; or
in a case that the second configuration information includes the first cell list, performing cell selection and/or reselection based on a result of a measured cell and/or a measurement result of a cell in the first cell list.

In some embodiments, the execution module 402 is further used for at least one of the following:
starting a frequency in the first frequency list to perform cell measurement; or
determining a target frequency based on the frequency that meets the reselection measurement condition and/or the frequency in the first frequency list, and starting the target frequency to perform cell measurement, where the target frequency does not include the frequency in the first frequency list.

In some embodiments, the execution module 402 is further used for at least one of the following:
obtaining, based on the result of the measured cell and/or the measurement result of the cell in the first cell list, a cell ranking that meets criteria of a high-priority frequency, an intra-frequency frequency, and a low-priority frequency; and
preferentially selecting the cell in the first cell list from the cell ranking to perform cell reselection; or
performing cell reselection in a cell, other than the cell in the first cell list, in the cell ranking; or
performing cell reselection after ranking the cell in the first cell list after other cells in the cell ranking.

In some embodiments, the third configuration information includes at least one of the following:
a first intra-frequency measurement threshold, where the first intra-frequency measurement threshold is lower than or higher than a reference intra-frequency measurement threshold;
a first inter-frequency or inter-system measurement threshold, where the first inter-frequency or inter-system measurement threshold is lower than or higher than a reference inter-frequency or inter-system measurement threshold;
an intra-frequency measurement threshold offset;
an inter-frequency or inter-system measurement threshold offset;
a first offset value, used to indicate an offset between a target cell and a camped-on cell;
a second cell list, where the second cell list includes the cell that supports network energy-saving;
an offset list, where the offset list includes an offset between each cell in the second cell list and the camped-on cell;
a second measurement threshold, where the second measurement threshold is a threshold used to start measurement for the cell that supports network energy-saving;
a first high-priority absolute threshold, where the first high-priority absolute threshold is an absolute threshold used to determine whether reselection to the cell that supports network energy-saving on a high-priority frequency is allowed;
a first low-priority absolute threshold, where the first low-priority absolute threshold is an absolute threshold used to determine whether reselection to the cell that supports network energy-saving on a low-priority frequency is allowed;
a first equal-priority absolute threshold, where the first equal-priority absolute threshold is an absolute threshold used to determine whether the cell that supports network energy-saving on an intra-frequency or an equal-priority frequency is allowed to participate in R-criterion ranking; or
a first energy-saving cell offset list, where the first energy-saving cell offset list is used to determine an offset between an energy-saving cell and the camped-on cell.

In some embodiments, the execution module 402 is further used for at least one of the following:
in a case that signal quality of the current cell is lower than the reference intra-frequency measurement threshold and the reference inter-frequency or inter-system measurement threshold, not starting cell measurement;
in a case that signal quality of the current cell is lower than the first intra-frequency measurement threshold and the first inter-frequency or inter-system measurement threshold, starting cell measurement;
in a case that signal quality of the current cell is lower than a second intra-frequency measurement threshold or is lower than a second inter-frequency or inter-system measurement threshold, starting cell measurement, where the second intra-frequency measurement threshold is determined by the reference intra-frequency measurement threshold and the intra-frequency measurement threshold offset, and the second inter-frequency or inter-system measurement threshold is determined by the reference inter-frequency or inter-system measurement threshold and the inter-frequency or inter-system measurement threshold offset;
in a case that signal quality of the current cell is lower than the second measurement threshold, starting network energy-saving cell measurement;
determining a cell reselection criterion based on the first offset value;
determining a cell reselection criterion based on the second cell list and the offset list;
determining a cell selection and/or reselection criterion based on the first high-priority absolute threshold;
determining a cell selection and/or reselection criterion based on the first low-priority absolute threshold;
determining a cell selection and/or reselection criterion based on the first equal-priority absolute threshold; or
determining a cell selection and/or reselection criterion based on the first energy-saving cell offset list.

In some embodiments, the target configuration information is carried by using at least one of the following: system information, or dedicated signaling.

FIG. 5 is a second schematic diagram of a structure of a cell selection and/or reselection apparatus according to an embodiment of this application. As shown in FIG. 5, the cell selection and/or reselection apparatus 500 includes:
a sending module 501, configured to send target configuration information to a terminal, where the target configuration information is used to assist the terminal in performing cell selection and/or reselection, and the target configuration information is related to network energy-saving; and
the target configuration information includes at least one of the following:
first configuration information, used to indicate whether the terminal is allowed to select and/or reselect to a cell;
second configuration information, including a first frequency list and/or a first cell list, where the first frequency list includes a frequency of a cell that supports network energy-saving and/or a frequency that supports network energy-saving, and the first cell list includes the cell that supports network energy-saving; or
third configuration information, used to indicate reselection information related to network energy-saving.

The cell selection and/or reselection apparatus provided in this embodiment of this application sends the target configuration information to the terminal, and after receiving the target configuration information related to network energy-saving, the terminal may determine, based on at least one of the first configuration information, the second configuration information, or the third configuration information in the target configuration information, whether selection and/or reselection to a cell is allowed, so that a terminal that supports network energy-saving can determine, based on an indication of a network, whether the terminal can access the cell and how to perform cell selection and/or reselection.

In some embodiments, the first configuration information includes at least one of the following:
a first parameter, used to determine information about whether the terminal is allowed to select and/or reselect to a cell; or
a second parameter, used to determine information about whether the terminal is allowed to reselect to an intra-frequency cell.

In some embodiments, the third configuration information includes at least one of the following:
a first intra-frequency measurement threshold, where the first intra-frequency measurement threshold is lower than or higher than a reference intra-frequency measurement threshold;
a first inter-frequency or inter-system measurement threshold, where the first inter-frequency or inter-system measurement threshold is lower than or higher than a reference inter-frequency or inter-system measurement threshold;
an intra-frequency measurement threshold offset;
an inter-frequency or inter-system measurement threshold offset;
a first offset value, used to indicate an offset between a target cell and a camped-on cell;
a second cell list, where the second cell list includes the cell that supports network energy-saving;
an offset list, where the offset list includes an offset between each cell in the second cell list and the camped-on cell;
a second measurement threshold, where the second measurement threshold is a threshold used to start measurement for the cell that supports network energy-saving;
a first high-priority absolute threshold, where the first high-priority absolute threshold is an absolute threshold used to determine whether reselection to the cell that supports network energy-saving on a high-priority frequency is allowed;
a first low-priority absolute threshold, where the first low-priority absolute threshold is an absolute threshold used to determine whether reselection to the cell that supports network energy-saving on a low-priority frequency is allowed;
a first equal-priority absolute threshold, where the first equal-priority absolute threshold is an absolute threshold used to determine whether the cell that supports network energy-saving on an intra-frequency or an equal-priority frequency is allowed to participate in R-criterion ranking; or
a first energy-saving cell offset list, where the first energy-saving cell offset list is used to determine an offset between an energy-saving cell and the camped-on cell.

In some embodiments, the target configuration information is carried by using at least one of the following: system information, or dedicated signaling.

The cell selection and/or reselection apparatus in the embodiments of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The cell selection and/or reselection apparatus provided in the embodiments of this application can implement the processes implemented in the embodiments of the cell selection and/or reselection method in FIG. 2 and FIG. 3, and a same technical effect is achieved. To avoid repetition, details are not described herein again.

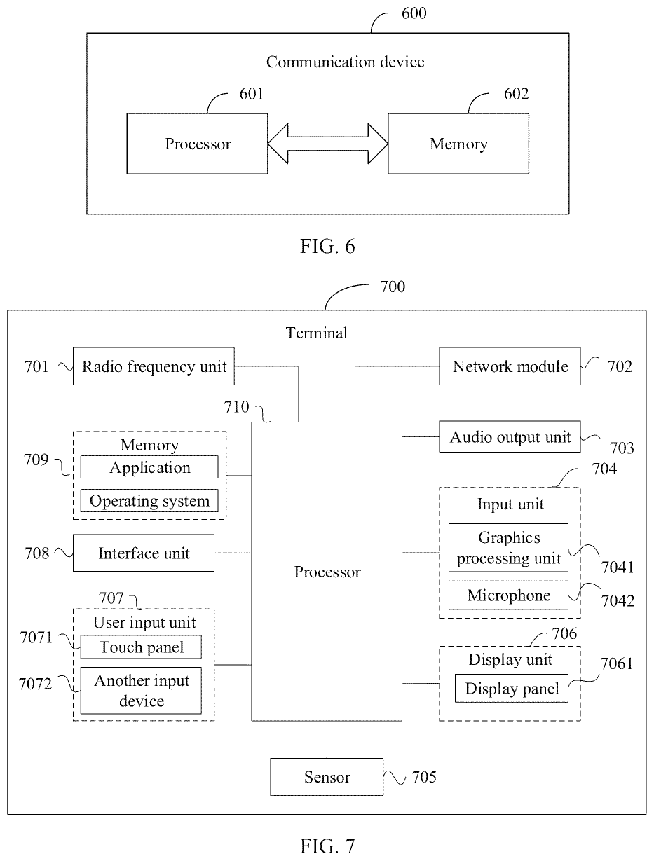

FIG. 6 is a schematic diagram of a structure of a communication device according to an embodiment of this application. As shown in FIG. 6, a communication device 600 includes a processor 601 and a memory 602, and the memory 602 stores a program or instructions that can be run on the processor 601. For example, in a case that the communication device 600 is a terminal, when the program or the instructions are executed by the processor 601, the steps of the foregoing embodiment of the cell selection and/or reselection method in FIG. 2 are implemented, and a same technical effect can be achieved. In a case that the communication device 600 is a network side device, when the program or the instructions are executed by the processor 601, the steps of the foregoing embodiment of the cell selection and/or reselection method in FIG. 3 are implemented, and a same technical effect can be achieved. To avoid repetition, details are not described herein again.

An embodiment of this application further provides a terminal, including a processor and a communication interface. The processor is configured to perform cell selection and/or reselection based on target configuration information, where the target configuration information is related to network energy-saving. The communication interface is configured to receive the target configuration information. The terminal embodiment is corresponding to the method embodiment on the terminal side, each implementation process and implementation of the method embodiment can be applied to the terminal embodiment, and a same technical effect can be achieved.

FIG. 7 is a schematic diagram of a structure of a terminal according to an embodiment of this application. As shown in FIG. 7, the terminal 700 includes but is not limited to at least some components in a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a Graphics Processing Unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 or another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and any memory of another proper type.

The processor 710 may include one or more processing units. In some embodiments, an application processor and a modem processor are integrated into the processor 710. The application processor mainly processes an operating system, a user interface, an application, or the like. The modem processor mainly processes a wireless communication signal, for example, a baseband processor. It may be understood that, the modem processor may not be integrated into the processor 710.

An embodiment of this application further provides a network side device, including a processor and a communication interface. The communication interface is configured to send target configuration information to a terminal, where the target configuration information is used to assist the terminal in performing cell selection and/or reselection, and the target configuration information is related to network energy-saving. This network side device embodiment is corresponding to the foregoing method embodiment of the network side device. Each implementation process and implementation of the foregoing method embodiment may be applicable to this network side device embodiment, and a same technical effect can be achieved.

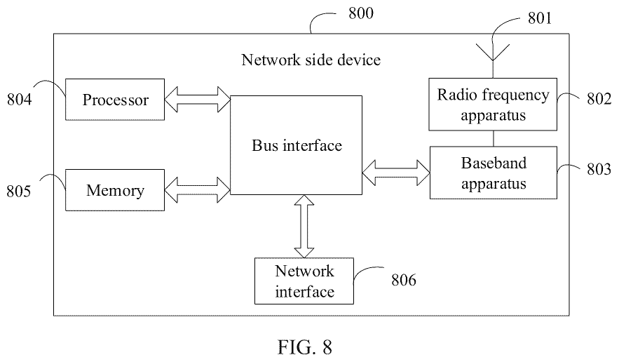

FIG. 8 is a schematic diagram of a structure of a network side device according to an embodiment of this application. As shown in FIG. 8, the network side device 800 includes an antenna 801, a radio frequency apparatus 802, a baseband apparatus 803, a processor 804, and a memory 805. The antenna 801 is connected to the radio frequency apparatus 802. In an uplink direction, the radio frequency apparatus 802 receives information through the antenna 801, and sends the received information to the baseband apparatus 803 for processing. In a downlink direction, the baseband apparatus 803 processes information that needs to be sent, and sends processed information to the radio frequency apparatus 802. The radio frequency apparatus 802 processes the received information, and sends processed information through the antenna 801.

In the foregoing embodiment, the method performed by the network side device may be implemented in the baseband apparatus 803. The baseband apparatus 803 includes a baseband processor.

For example, the baseband apparatus 803 may include at least one baseband board. A plurality of chips are disposed on the baseband board. As shown in FIG. 8, one chip is, for example, a baseband processor, and is connected to the memory 805 by using a bus interface, to invoke a program in the memory 805 to perform the operations of the network device shown in the foregoing method embodiment.

The network side device may further include a network interface 806, and the interface is, for example, a common public radio interface (CPRI).

The network side device 800 in this embodiment of the present application further includes instructions or a program that is stored in the memory 805 and that can be run on the processor 804. The processor 804 invokes the instructions or the program in the memory 805 to perform the foregoing cell selection and/or reselection method, and a same technical effect is achieved. To avoid repetition, details are not described herein again.

An embodiment of this application further provides a cell selection and/or reselection system, including a terminal and a network side device. The terminal may be configured to perform the steps of the cell selection and/or reselection method shown in FIG. 2, and the network side device may be configured to perform the steps of the cell selection and/or reselection method shown in FIG. 3.

An embodiment of this application further provides a readable storage medium. The readable storage medium may be non-volatile or volatile. The readable storage medium stores a program or instructions, and the program or the instructions are executed by a processor to implement the processes of the foregoing method of the cell selection and/or reselection method, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or instructions to implement the processes of the foregoing embodiment of the cell selection and/or reselection method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the cell selection and/or reselection method, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A cell selection or reselection method, comprising:
receiving, by a terminal, target configuration information; and
performing, by the terminal, cell selection or reselection based on the target configuration information, wherein the target configuration information is related to network energy-saving,
wherein the target configuration information comprises at least one of the following:
first configuration information, used to indicate whether the terminal is allowed to select or reselect to a cell;
second configuration information, comprising a first frequency list or a first cell list, wherein the first frequency list comprises a frequency of a cell that supports network energy-saving or a frequency that supports network energy-saving, and the first cell list comprises the cell that supports network energy-saving; or
third configuration information, used to indicate reselection information related to network energy-saving.

2. The cell selection or reselection method according to claim 1, wherein the first configuration information comprises at least one of the following:
a first parameter, used to determine information about whether the terminal is allowed to select or reselect to a cell; or
a second parameter, used to determine information about whether the terminal is allowed to reselect to an intra-frequency cell.

3. The cell selection or reselection method according to claim 2, wherein the performing, by the terminal, cell selection or reselection based on the target configuration information comprises at least one of the following:
when the first configuration information comprises the first parameter and the first parameter is configured as barred, the terminal is barred from selecting or reselecting to the cell;
when the first configuration information comprises the first parameter and the first parameter is configured as not barred, the terminal is allowed to select or reselect to the cell;
when the first configuration information does not comprise the first parameter, the terminal is barred from selecting or reselecting to the cell, or the terminal is allowed to select or reselect to the cell;
when the first configuration information comprises the second parameter and the second parameter is configured as allowed, the terminal is allowed to select or reselect to an unbarred intra-frequency cell;
when the first configuration information comprises the second parameter and the second parameter is configured as not allowed, the terminal is not allowed to select or reselect to an intra-frequency cell; or
when the first configuration information does not comprise the second parameter, the terminal is barred from selecting or reselecting to the cell.

4. The cell selection or reselection method according to claim 1, wherein the performing, by the terminal, cell selection or reselection based on the target configuration information comprises at least one of the following:
when the second configuration information comprises the first frequency list, performing, by the terminal, cell measurement based on a frequency that meets a reselection measurement condition or a frequency in the first frequency list; or
when the second configuration information comprises the first cell list, performing, by the terminal, cell selection or reselection based on a result of a measured cell or a measurement result of a cell in the first cell list.

5. The cell selection or reselection method according to claim 4, wherein the performing, by the terminal, cell measurement based on a frequency that meets a reselection measurement condition or a frequency in the first frequency list comprises either of the following:
starting, by the terminal, a frequency in the first frequency list to perform cell measurement; or
determining, by the terminal, a target frequency based on the frequency that meets the reselection measurement condition or the frequency in the first frequency list, and starting the target frequency to perform cell measurement, wherein the target frequency does not comprise the frequency in the first frequency list.

6. The cell selection or reselection method according to claim 4, wherein the performing, by the terminal, cell selection or reselection based on a result of a measured cell or a measurement result of a cell in the first cell list comprises:
obtaining, by the terminal based on the result of the measured cell or the measurement result of the cell in the first cell list, a cell ranking that meets criteria of a high-priority frequency, an intra-frequency frequency, and a low-priority frequency; and
preferentially selecting, by the terminal, the cell in the first cell list from the cell ranking to perform cell reselection; or
performing, by the terminal, cell reselection in a cell, other than the cell in the first cell list, in the cell ranking; or
performing, by the terminal, cell reselection after ranking the cell in the first cell list after other cells in the cell ranking.

7. The cell selection or reselection method according to claim 1, wherein the third configuration information comprises at least one of the following:
a first intra-frequency measurement threshold, wherein the first intra-frequency measurement threshold is lower than or higher than a reference intra-frequency measurement threshold;
a first inter-frequency or inter-system measurement threshold, wherein the first inter-frequency or inter-system measurement threshold is lower than or higher than a reference inter-frequency or inter-system measurement threshold;
an intra-frequency measurement threshold offset;
an inter-frequency or inter-system measurement threshold offset;
a first offset value, used to indicate an offset between a target cell and a camped-on cell;
a second cell list, wherein the second cell list comprises the cell that supports network energy-saving;
an offset list, wherein the offset list comprises an offset between each cell in the second cell list and the camped-on cell;
a second measurement threshold, wherein the second measurement threshold is a threshold used to start measurement for the cell that supports network energy-saving;
a first high-priority absolute threshold, wherein the first high-priority absolute threshold is an absolute threshold used to determine whether reselection to the cell that supports network energy-saving on a high-priority frequency is allowed;
a first low-priority absolute threshold, wherein the first low-priority absolute threshold is an absolute threshold used to determine whether reselection to the cell that supports network energy-saving on a low-priority frequency is allowed;
a first equal-priority absolute threshold, wherein the first equal-priority absolute threshold is an absolute threshold used to determine whether the cell that supports network energy-saving on an intra-frequency or an equal-priority frequency is allowed to participate in R-criterion ranking; or
a first energy-saving cell offset list, wherein the first energy-saving cell offset list is used to determine an offset between an energy-saving cell and the camped-on cell.

8. The cell selection or reselection method according to claim 7, wherein the performing, by the terminal, cell selection or reselection based on the target configuration information comprises at least one of the following:
when signal quality of the current cell is lower than the reference intra-frequency measurement threshold and the reference inter-frequency or inter-system measurement threshold, skipping starting, by the terminal, cell measurement;
when signal quality of the current cell is lower than the first intra-frequency measurement threshold and the first inter-frequency or inter-system measurement threshold, starting, by the terminal, cell measurement;
when signal quality of the current cell is lower than a second intra-frequency measurement threshold or is lower than a second inter-frequency or inter-system measurement threshold, starting, by the terminal, cell measurement, wherein the second intra-frequency measurement threshold is determined by the reference intra-frequency measurement threshold and the intra-frequency measurement threshold offset, and the second inter-frequency or inter-system measurement threshold is determined by the reference inter-frequency or inter-system measurement threshold and the inter-frequency or inter-system measurement threshold offset;
when signal quality of the current cell is lower than the second measurement threshold, starting, by the terminal, network energy-saving cell measurement;
determining, by the terminal, a cell reselection criterion based on the first offset value;
determining, by the terminal, a cell reselection criterion based on the second cell list and the offset list;
determining, by the terminal, a cell selection or reselection criterion based on the first high-priority absolute threshold;
determining, by the terminal, a cell selection or reselection criterion based on the first low-priority absolute threshold;
determining, by the terminal, a cell selection or reselection criterion based on the first equal-priority absolute threshold; or
determining, by the terminal, a cell selection or reselection criterion based on the first energy-saving cell offset list.

9. The cell selection or reselection method according to claim 1, wherein the target configuration information is carried by using at least one of the following: system information, or dedicated signaling.

10. A cell selection or reselection method, comprising:
sending, by a network side device, target configuration information to a terminal, wherein the target configuration information is used to assist the terminal in performing cell selection or reselection, and the target configuration information is related to network energy-saving; and
the target configuration information comprises at least one of the following:
first configuration information, used to indicate whether the terminal is allowed to select or reselect to a cell;
second configuration information, comprising a first frequency list or a first cell list, wherein the first frequency list comprises a frequency of a cell that supports network energy-saving or a frequency that supports network energy-saving, and the first cell list comprises the cell that supports network energy-saving; or
third configuration information, used to indicate reselection information related to network energy-saving.

11. The cell selection or reselection method according to claim 10, wherein the first configuration information comprises at least one of the following:
a first parameter, used to determine information about whether the terminal is allowed to select or reselect to a cell; or
a second parameter, used to determine information about whether the terminal is allowed to reselect to an intra-frequency cell.

12. The cell selection or reselection method according to claim 10, wherein the third configuration information comprises at least one of the following:
a first intra-frequency measurement threshold, wherein the first intra-frequency measurement threshold is lower than or higher than a reference intra-frequency measurement threshold;
a first inter-frequency or inter-system measurement threshold, wherein the first inter-frequency or inter-system measurement threshold is lower than or higher than a reference inter-frequency or inter-system measurement threshold;
an intra-frequency measurement threshold offset;
an inter-frequency or inter-system measurement threshold offset;
a first offset value, used to indicate an offset between a target cell and a camped-on cell;
a second cell list, wherein the second cell list comprises the cell that supports network energy-saving;
an offset list, wherein the offset list comprises an offset between each cell in the second cell list and the camped-on cell;
a second measurement threshold, wherein the second measurement threshold is a threshold used to start measurement for the cell that supports network energy-saving;
a first high-priority absolute threshold, wherein the first high-priority absolute threshold is an absolute threshold used to determine whether reselection to the cell that supports network energy-saving on a high-priority frequency is allowed;
a first low-priority absolute threshold, wherein the first low-priority absolute threshold is an absolute threshold used to determine whether reselection to the cell that supports network energy-saving on a low-priority frequency is allowed;
a first equal-priority absolute threshold, wherein the first equal-priority absolute threshold is an absolute threshold used to determine whether the cell that supports network energy-saving on an intra-frequency or an equal-priority frequency is allowed to participate in R-criterion ranking; or
a first energy-saving cell offset list, wherein the first energy-saving cell offset list is used to determine an offset between an energy-saving cell and the camped-on cell.

13. The cell selection or reselection method according to claim 10, wherein the target configuration information is carried by using at least one of the following: system information or dedicated signaling.

14. A terminal, comprising a processor and a memory storing a program or an instruction that is capable of running on the processor, wherein the program or the instruction, when executed by the processor, causes the terminal to perform:
receiving target configuration information; and
performing cell selection or reselection based on the target configuration information, wherein the target configuration information is related to network energy-saving,
wherein the target configuration information comprises at least one of the following:
first configuration information, used to indicate whether the terminal is allowed to select or reselect to a cell;
second configuration information, comprising a first frequency list or a first cell list, wherein the first frequency list comprises a frequency of a cell that supports network energy-saving or a frequency that supports network energy-saving, and the first cell list comprises the cell that supports network energy-saving; or
third configuration information, used to indicate reselection information related to network energy-saving.

15. The terminal according to claim 14, wherein the first configuration information comprises at least one of the following:
a first parameter, used to determine information about whether the terminal is allowed to select or reselect to a cell; or
a second parameter, used to determine information about whether the terminal is allowed to reselect to an intra-frequency cell.

16. The terminal according to claim 15, wherein the performing, by the terminal, cell selection or reselection based on the target configuration information comprises at least one of the following:
when the first configuration information comprises the first parameter and the first parameter is configured as barred, the terminal is barred from selecting or reselecting to the cell;
when the first configuration information comprises the first parameter and the first parameter is configured as not barred, the terminal is allowed to select or reselect to the cell;
when the first configuration information does not comprise the first parameter, the terminal is barred from selecting or reselecting to the cell, or the terminal is allowed to select or reselect to the cell;
when the first configuration information comprises the second parameter and the second parameter is configured as allowed, the terminal is allowed to select or reselect to an unbarred intra-frequency cell;
when the first configuration information comprises the second parameter and the second parameter is configured as not allowed, the terminal is not allowed to select or reselect to an intra-frequency cell; or
when the first configuration information does not comprise the second parameter, the terminal is barred from selecting or reselecting to the cell.

17. The terminal according to claim 14, wherein the performing, by the terminal, cell selection or reselection based on the target configuration information comprises at least one of the following:
when the second configuration information comprises the first frequency list, performing, by the terminal, cell measurement based on a frequency that meets a reselection measurement condition or a frequency in the first frequency list; or
when the second configuration information comprises the first cell list, performing, by the terminal, cell selection or reselection based on a result of a measured cell or a measurement result of a cell in the first cell list.

18. The terminal according to claim 17, wherein the performing, by the terminal, cell measurement based on a frequency that meets a reselection measurement condition or a frequency in the first frequency list comprises either of the following:
starting, by the terminal, a frequency in the first frequency list to perform cell measurement; or
determining, by the terminal, a target frequency based on the frequency that meets the reselection measurement condition or the frequency in the first frequency list, and starting the target frequency to perform cell measurement, wherein the target frequency does not comprise the frequency in the first frequency list.

19. The terminal according to claim 17, wherein the performing, by the terminal, cell selection or reselection based on a result of a measured cell or a measurement result of a cell in the first cell list comprises:
obtaining, by the terminal based on the result of the measured cell or the measurement result of the cell in the first cell list, a cell ranking that meets criteria of a high-priority frequency, an intra-frequency frequency, and a low-priority frequency; and
preferentially selecting, by the terminal, the cell in the first cell list from the cell ranking to perform cell reselection; or
performing, by the terminal, cell reselection in a cell, other than the cell in the first cell list, in the cell ranking; or
performing, by the terminal, cell reselection after ranking the cell in the first cell list after other cells in the cell ranking.

20. The terminal according to claim 14, wherein the third configuration information comprises at least one of the following:
a first intra-frequency measurement threshold, wherein the first intra-frequency measurement threshold is lower than or higher than a reference intra-frequency measurement threshold;
a first inter-frequency or inter-system measurement threshold, wherein the first inter-frequency or inter-system measurement threshold is lower than or higher than a reference inter-frequency or inter-system measurement threshold;
an intra-frequency measurement threshold offset;
an inter-frequency or inter-system measurement threshold offset;
a first offset value, used to indicate an offset between a target cell and a camped-on cell;
a second cell list, wherein the second cell list comprises the cell that supports network energy-saving;
an offset list, wherein the offset list comprises an offset between each cell in the second cell list and the camped-on cell;
a second measurement threshold, wherein the second measurement threshold is a threshold used to start measurement for the cell that supports network energy-saving;
a first high-priority absolute threshold, wherein the first high-priority absolute threshold is an absolute threshold used to determine whether reselection to the cell that supports network energy-saving on a high-priority frequency is allowed;
a first low-priority absolute threshold, wherein the first low-priority absolute threshold is an absolute threshold used to determine whether reselection to the cell that supports network energy-saving on a low-priority frequency is allowed;
a first equal-priority absolute threshold, wherein the first equal-priority absolute threshold is an absolute threshold used to determine whether the cell that supports network energy-saving on an intra-frequency or an equal-priority frequency is allowed to participate in R-criterion ranking; or
a first energy-saving cell offset list, wherein the first energy-saving cell offset list is used to determine an offset between an energy-saving cell and the camped-on cell.
